(19) United States
(12) Patent Application Publication
(10) Pub. No.: US 2026/0245215 A1
(43) Pub. Date: Aug. 20, 2026

(54) PORTABLE RAILROAD GRADE CROSSING MONITORING SYSTEM

(71) Applicant: University of South Carolina, Columbia, SC (US)

(72) Inventor: Yu Qian, Irmo, SC (US)

(73) Assignee: University of South Carolina, Columbia, SC (US)

(21) Appl. No.: 19/054,978

(22) Filed: Feb. 17, 2025

(51) Int. Cl. G06T 7/194; B61L 23/04; G06V 10/26; G06V 10/82; G06V 20/52

(52) U.S. Cl. CPC G06T 7/194; B61L 23/041; G06V 10/26; G06V 10/82; G06V 20/52

(57) ABSTRACT

Described herein is a portable edge-computing system, and methods for use and making same, to detect moving and stationed objects at railroad-highway grade crossing areas in order to detect foreign objects that do not belong at or near the specific location to identify potential threats, especially for detecting pedestrians and vehicles at railroad-highway grade crossing areas.

### STATEMENT REGARDING FEDERALLY SPONSORED RESEARCH

This invention was made with government support under 693JJ6-20-C-000021 awarded by the U.S. Department of Transportation. The government has certain rights in the invention.

### TECHNICAL FIELD

The subject matter disclosed herein is generally directed to a portable edge-computing system, and methods for use and making same, to detect moving and stationed objects at railroad-highway grade crossing areas in order to detect foreign objects that do not belong at or near the specific location to identify potential threats, especially for detecting pedestrians and vehicles at railroad-highway grade crossing areas.

### BACKGROUND

According to the Federal Railroad Administration's “Report to Congress on the National Strategy to Prevent Trespassing on Railroad Property,” trespassing currently ranks as the leading cause of all railroad-related fatalities. The death toll from trespassing, which encompasses both unlawful entry and lingering within railroad right-of-ways, actually surpasses the number of fatalities resulting from collisions between vehicles and trains.

Every year, a significant number of accidents occur at railroad crossings, involving collisions between trains and pedestrians, vehicles, or other obstacles. Whether due to intentional actions or inadvertent mistakes, pedestrians and vehicles often find themselves in the high-risk zone of the grade crossing. By the time a train operator is able to detect these obstructions, it is generally too late to halt the train safely.

The above issues continue to exist, even in the face of improved railroad safety standards. What is needed is a monitoring system designed for easy deployment at grade crossings to provide real-time alerts, helping to prevent such accidents from occurring. Thus, accordingly, it is an object of the present disclosure to provide a portable monitoring solution designed for placement adjacent to railroad crossings. This system is engineered to detect and identify foreign objects—be it pedestrians, vehicles, fallen trees, or even misplaced packages—that should not be within the grade crossing zone. Once such objects are detected, the system immediately triggers an alarm, serving as an early warning system to avert potential collisions at the crossing.

Railroad safety remains critically challenged by accidental intrusions at rail crossings, a major cause of fatalities and injuries. Notable incidents, such as the June 2022 collision near Mendon, Missouri, and the June 2023 accident in Lower Richland County, South Carolina, highlight the urgent need for improved safety measures at these crossings. Despite significant advancements over recent decades, including the installation of signaling units and gate arms, collisions at grade crossings continue to result in approximately 250 deaths and 775 injuries annually in the United States.

The Federal Railroad Administration (FRA) reports that the United States has approximately 210,000 public and private grade crossings, with the majority open to public access (Ogden & Cooper, 2019). Since the 1980s, there has been a consistent and significant decrease in collisions at these crossings (Lifesaver, 2023). This positive trend is largely attributed to safety enhancements such as installing signaling units and gate arms at these critical junctions. Despite these considerable improvements in railway safety over recent decades, collisions at grade crossings continue to cause railroad-related fatalities. According to FRA data, from 2018 to 2022, the U.S. averaged approximately 2,144 collisions at these crossings annually, resulting in about 250 deaths and 775 injuries each year (Lifesaver, 2023). These statistics underscore these accidents' significant societal burden, including disruptions to highway and rail operations and substantial adverse impacts on local economies and communities.

In recent years, North America has experienced a disturbing rise in accidents and fatalities on railroad rights-of-way (ROW), with trespassing incidents contributing to approximately 70% of these cases. Alarmingly, more than 60% of collisions occur at crossings equipped with automatic warning systems, and 34.7% happen at crossings featuring flashing lights and gates (FRA, 2019). This situation highlights a critical need to enhance existing grade crossing warning systems. The main limitation of current systems is that while flashing lights and gate arms signal the presence of an approaching train, they are ineffective in detecting and managing unexpected trespassing or track fouling incidents, which may involve a pedestrian, vehicle, or an unforeseen obstruction on the crossings. In such situations, onboard engineers can only respond to unusual activity at the crossing that falls within their line of sight, often resulting in delayed and ineffective countermeasures.

The primary limitation of current warning systems is their high-cost and limited capability to detect and manage unexpected trespassing or obstructions at crossings. Existing systems alert only to approaching trains but fail to address unforeseen hazards like pedestrians, vehicles, or other objects that may be on the tracks. This gap necessitates the development of a more advanced, real-time monitoring system that enhances railroad safety and operational reliability. In response to this need, the rapid advancement of deep learning and Artificial Intelligence (AI) has led to the development of Convolutional Neural Networks (CNNs) for various computer vision applications, including railroad safety. However, existing models often struggle with detecting unanticipated objects and are typically designed for server-based environments with high-performance GPUs, limiting their applicability in field deployments.

Citation or identification of any document in this application is not an admission that such a document is available as prior art to the present disclosure.

### SUMMARY

The above objectives are accomplished according to the present disclosure by providing in one aspect a portable railroad grade crossing monitoring system. The system may include at least one input head to both identify and discern foreground objects within at least one visual scene, at least three processors configured to act independently from one another with a first processor configured to process foreground detection, a second processor configured to process object classification, a third processor configured to process motion tracking, and each processor is assigned to a separate central processing unit core. The input head is configured to compare at least one current frame and at least one static background and further configured to isolate at least one dynamic object or at least one static object in a foreground of the at least one visual scene to detect at least one moving object against at least one background image. Further, the at least one background image may change over time. Yet again, the input head may be supported by multiple algorithms. Still yet, the multiple algorithms may be configured to analyze at least one temporal and at least one spatial variation between consecutive video frames to dynamically differentiate between foreground elements and background scenery. Moreover, system may employ at least one data association technique algorithm and at least one motion prediction algorithm to track a trajectory of at least one detected object across successive video frames. Still yet, the system may employ Zero-shot learning to recognize and classify at least one image from at least one category of images never seen during training of the monitoring system. Yet again, the system may employ an anchor-free methodology instead of an anchor-based methodology. Furthermore, the system may maintain consistent object identities across multiple frames in dynamic environments. Moreover, the multiple processors may transfer information to one another via at least one queue. Still yet further, the monitoring system may detect and segment at least one foreground object from a background and classify the at least one foreground object into at least one category and track movement of the at least one foreground object across multiple frames.

In a further aspect, a method for monitoring a railroad grade crossing may be provided. The method may include positioning at least one device comprising at least one input head at a railroad grade crossing, configuring the at least one input head to harmonize weight between at least one video frame input and at least one background image input, wherein the at least one input head transforms both the at least one video frame input and at least one background image input into at least one first feature map and at least one second feature map wherein the at least one first feature map and the at least one second feature map are identical in size; and configuring the at least one device to comprise at least three processors to act independently from one another including; a first processor configured to process foreground detection, a second processor configured to process object classification, a third processor configured to process motion tracking; and each processor is assigned to a separate central processing unit core. Further, the method may configure the at least one input head to comprise at least a first branch and a second branch with the first branch and the second branch are further configured to have at least one single convolutional layer. Yet again, the first branch may be configured to process the at least one video frame input and the second branch may be configured to process the at least one background image input. Still yet, the at least one first feature map and the at least one second feature map may be configured to be concatenated to form at least one combined channel feature map. Further again, the at least one combined channel feature map may be configured to undergo a final convolutional transformation to compress the at least one combined channel feature map into a compressed output. Furthermore, the compressed output may be configured to be compatible with a backbone of a YOLOv8 architecture. Further again, the input head may be to perform foreground detection. Again still, the input head may be configured to classify foreground objects in a context-aware manner. Further again, the system may be configured to maintain consistent object identities across frames in at least one dynamic environment. Again further, the system may be configured to detect and segment at least one foreground object from a background and classify the at least one foreground object into at least one category and track movement of the at least one foreground object across multiple frames.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows an overview of each module of the proposed i-ASAP.

FIG. 2 shows one example of results obtained by the current system showing images with moving targets detected by the ATR algorithm.

FIG. 3 shows optical flow target tracking from the airborne platform.

FIG. 4 shows one example of a Honic PoE IP security camera.

FIG. 5 shows one example of a NVIDIA Jetson Nano development kit.

FIG. 6 shows a CNN-based target classification displaying at: (a) vehicle with top 5 predicted classes; and (b) vehicle and human classification with overlaid detection.

FIG. 7 shows a graph of development risk for the disclosure.

FIG. 8 shows a photo of differences between foreground segmentation and object detection (from top to bottom: foreground segmentation, object detection).

FIG. 9 shows three types of CNN-based foreground segmentation algorithms.

FIG. 10 shows one embodiment of an overall approach of the proposed YOLOv8-FG system.

FIG. 13 shows an input head structure of YOLO-FG.

FIG. 14 shows one embodiment of YOLOv8 network architecture.

FIG. 15 shows an illustration of Contrastive Language-Image Pre-training (CLIP) model architecture.

FIG. 16 shows a flow-chart of Deep-SORT.

FIG. 17 shows a single-processor vs multi-processor pipeline arrangement.

FIG. 18 shows Table 1-F-measure comparison of different foreground algorithms among CDnet2014 dataset.

FIG. 19 shows example detection results on CDnet 2014 dataset.

FIG. 20 shows a graph comparison of sequential pipeline and multi-processor pipeline.

FIG. 21 shows one embodiment of a hardware implementation of the current disclosure.

FIG. 22 shows field testing sites in Columbia, SC.

FIG. 23 shows field testing near 409 Main St, Columbia, SC 29201.

FIG. 24 shows field testing near 718 Devine St, Columbia, SC 29201.

FIG. 25 shows field testing near 230 Huger St, Columbia, SC 29201.

FIG. 26 shows field testing near 216 Tryon St, Columbia, SC 29201.

FIG. 27 shows field testing near 949 Rosewood Dr, Columbia, SC 29201.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g., given data set, art accepted standard, and/or with e.g., a given confidence interval (e.g., 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used interchangeably herein, the terms “sufficient” and “effective,” can refer to an amount (e.g., mass, volume, dosage, concentration, and/or time period) needed to achieve one or more desired and/or stated result(s). For example, a therapeutically effective amount refers to an amount needed to achieve one or more therapeutic effects.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g., a web interface.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference. This specifically includes, but is not limited to, doi.org/10.1177/03611981231159406.

### KITS

Any of the systems and methods for making or using same described herein can be presented as a combination kit. As used herein, the terms “combination kit” or “kit of parts” refers to the systems and methods for making or using same and any additional components that are used to package, sell, market, deliver, and/or provide the systems and methods for making or using same including combination of elements or single elements employed in the system or methods. Such additional components include, but are not limited to, packaging, shipping containers/materials, assembly tools, and the like. When one or more of the systems and methods for making or using same described herein described herein or a combination thereof (e.g., components or portions of the system contained in the kit are provided simultaneously, the combination kit can contain the systems and methods for making or using same in a single embodiment, such as a complete, ready to use system, or in separate components or assemblies. When the systems and methods for making or using same described herein or a combination thereof and/or kit components are not provided simultaneously, the combination kit can contain each system, or the components needed for the methods in separate embodiments. The separate kit components can be contained in a single package or in separate packages within the kit.

In some embodiments, the combination kit also includes instructions printed on or otherwise contained in a tangible medium of expression. The instructions can provide information regarding the systems and methods for making or using same, safety information regarding the content of the systems and methods for making or using same, instructions for use, and/or maintenance and upkeep regimen(s) for the systems or components for the methods for making or using same contained therein. In some embodiments, the instructions can provide directions and protocols for deploying and using the systems and methods for making or using same. In some embodiments, the instructions can provide one or more embodiments of the systems and methods for making or using same thereof such as any of the systems and methods described in greater detail elsewhere herein.

The current disclosure has developed a portable edge-computing system based on the Foreground Extraction Network to detect moving and stationed objects. This system aims to detect any foreign objects that do not belong to the specific location to identify potential threats, especially for detecting trespassing pedestrians and vehicles at the railroad-highway grade crossing areas. The system is combined with a camera, an edge-computing kit incorporated with our own code, a battery, and an audio alarm device.

The objective of this disclosure is to develop an affordable and field-deployable Intelligent Abnormal Situation Awareness Platform (i-ASAP) that is able to detect and evaluate anomalous situations (trespass and suicide) at grade crossings and critical locations along the railroad, and share the real-time risk information with local law enforcement and approaching trains for enhanced safety. The system will integrate a continuous surveillance unit, a real-time communication unit, and computer vision as well as a deep-learning artificial intelligence (AI) unit on an edge computing platform. This disclosure will significantly enhance situational awareness at grade crossings or other installation locations, mitigate train collision risks, reduce local law enforcement workloads, improve quality of life, and benefit all the stakeholders in industry, railroads, and local, state, and federal administration and legislation.

According to the Report to Congress “National Strategy to Prevent Trespassing on Railroad Property”, see//railroads.dot.gov/elibrary/national-strategy-prevent-trespassing-railroad-property, issued by the Federal Railroad Administration, trespassing is currently the number one cause of all railroad related deaths. The number of fatalities due to trespassing, including both illegally entering and remaining in the railroad right-of-way is even higher than the number of fatalities due to collision between vehicles and trains. Just during the first seven months of 2018, there were 324 trespassing fatalities reported. Moreover, the annual of trespassing fatalities is increasing, from 725 in 2012 to 855 in 2017, while other railroad related fatalities have continued to decrease over the years. Not only the loss of lives, but also the financial and societal impact associated with those accidents is enormous. The FRA report indicated that the accidents during 2012 to 2016 have cost $43 billion to our nation. Unfortunately, at present there is no dedicated system to tackle the issues associated with trespassing or other anomalous situations (e.g., suicide) and enhance railroad safety. Clearly, it is in urgent need to develop practical solutions to trespassing and suicide prevention and mitigate risks of potential accidents.

Railroad crossings are the locations where most trespassing incidents happens, and almost three quarters of all the trespassing was located within 1000 feet of a crossing. This is largely due to the fact that both pedestrians and vehicles cross the track through grade crossings. Therefore, it is a high priority to address trespassing within the grade crossing area. However, it should be noted that the proposed technology described herein is also generally applicable to broader areas along the track segments that are far away from the crossings, where the other 25% of fatalities occur.

To address such an urgent need, the current disclosure provides the first-ever Intelligent Abnormal Situation Awareness Platform (i-ASAP) that will automatically monitor the area of interest, especially around grade crossings, to identify anomalous activities that may potentially lead to trespassing and suicide and raise serious safety concerns. The detected suspicious activities will be shared in real-time with both local law enforcement agencies and approaching trains for rapid response. This will allow the local law enforcement to judiciously utilize the resources (e.g., reducing unnecessary patrolling or investigation) and the trains to take preventative actions (e.g., slow down or stop) to avoid collisions. i-ASAP features salient wireless communication, computer vision, AI and data analytics, and in-situ information sharing on an embedded and autonomous edge computing platform which can be stationed at the grade crossing, installed at any critical location along the railroad, or mounted on UAVs for periodic track segments patrol. The proposed i-ASAP represents a holistic solution for enhanced situational awareness and collision prevention that has never been explored before for railroad engineering.

### Technology Assessment

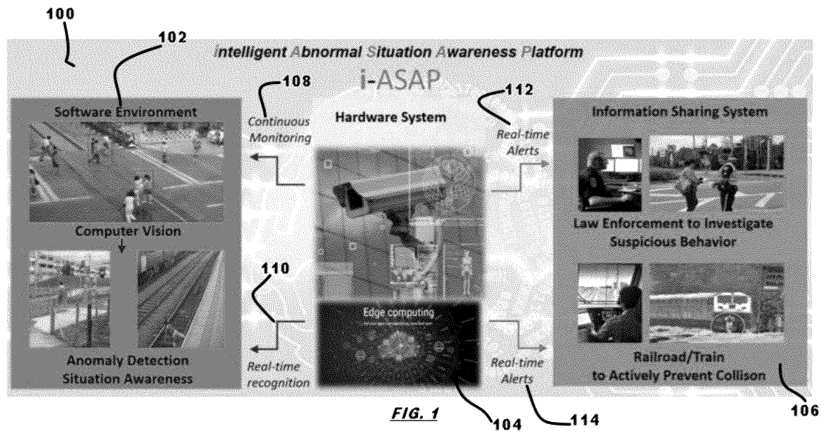

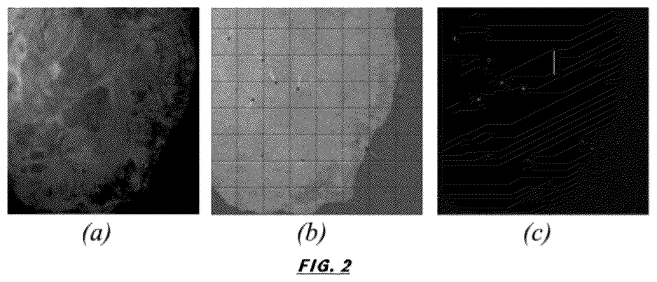

The evaluation and prediction of any abnormal situation at railroad grade crossings essentially depends on the information/data from two sources: the objects within the crossing area and the trajectories of the objects around and/or through the crossing area. Based on the understanding, the current disclosure developed i-ASAP for real-time situation awareness, abnormal detection at crossings, and information sharing for proactive actives that will be especially useful for both the railroads and the first responders. FIG. 1 illustrates the systematic organization 100 of the proposed i-ASAP framework to be built on an embedded mobile Cyber-Physical System (m-CPS) architecture. Our tool consists of three key modules: Module I: AI-based Anomaly Detection Software 102; Module II: Image Acquisition and Edge Computing Hardware 104; and Module III: Active Information Sharing 106 (with involved parties). Systematic organization 100 also includes continuous monitoring 108, real-time recognition 110 as well as real time law enforcement alerts 112, and real time railroad/train alerts 114.

The i-ASAP is developed based on relatively mature technologies that have been applied in other fields. Module I 102 (AI-based Anomaly Detection Software), will be developed leveraging our team's previous experience on advanced automatic target recognition (ATR) and AI application obtained in the previous FRA sponsored project and other defense and aerospace-related projects. Therefore, the key algorithms to be applied in this project have been successfully developed and deployed in pertinent environments. Our ATR technology has demonstrated accurate detection and tracking of moving objects, and its performance will be improved in terms of trajectory extraction and anomaly detection by harnessing cutting-edge AI algorithms. Module II 104 (Image Acquisition and Edge Computing Hardware) focuses on the hardware development. After the AI machine is trained and the anomaly detection and the identification algorithm is established, the software will be implemented onto a mobile, edge computing platform with a tailored architecture to achieve a balance among computing efficiency for real-time decision making and information sharing, investment and maintenance cost, and power consumption for continuous monitoring.

The end users of the proposed i-ASAP are the railroads and the first responders, and therefore, the capability to share the critical information is essential. Fortunately, with the foundation laid by the previous FRA-sponsored research, a secure communication channel has been established to share the train information to a traffic monitoring unit and to the first responders dispatching center. Module III 106 (Active Information Sharing) in this project will bring the information sharing to a completely new but feasible level. Different from the previously FRA-sponsored project, critical visual evidence, such as images of a car or a pedestrian halted in the crossing will be shared to both the railroads and the first responders upon detection to assist any decisions on proactive activities to prevent undesirable consequences. The research team has initiated the discussion and gained support from both CSX and the City of Columbia to the two-way information sharing.

### Development Framework

“i-ASAP” technology leverages the extensive R&D experience of the research team on railroad communication, computer vision, and AI and machine learning. The current disclosure is based on low-cost, commercial-off—the shelf (COT) surveillance cameras with edge computing architecture, and the integrated solution system can be installed at a selected grade crossing or track location. Our industrial partner, CFD Research Corporation (CFDRC) has developed and packaged relevant AI software and hardware platform in prior defense-related applications, and CSX has already agreed to provide the access to test locations, track access, and historical collision video database for AI training and technology validation.

The current disclosure provides a first-of-its-kind, low-cost, field-deployable Intelligent Abnormal Situation Awareness Platform (i-ASAP). i-ASAP will enable groundbreaking capabilities to detect anomalous situations around the grade crossings and along the track segments, evaluate associated risks, and provide real-time information of the suspicious activities to both local law enforcement agencies and nearby trains in operation. It will significantly reduce crossing collision risk, protect financial and human resources, and improve life quality.

The research team has already developed an automatic target recognition (ATR) algorithm for a previous FRA sponsored research project. For this project, the developed ATR module will be enhanced to not only detect and track objects but to extract the trajectory of the target as a time series data. The trajectories will be used to train the initial AI model that will be used as the baseline to identify any anomalous behavior of the object being monitored.

In order to enable in-situ image analysis and AI inference using the algorithm described above, this disclosure employs an edge computing platform and integration strategy. Further, the system may include a low-cost camera and mobile computing board assembled in an architecture to balance among computing efficiency, investment and maintenance costs, and power consumption of the integrated system for this project.

Further, a secured channel that facilitates information sharing from train to a cloud data processing unit and to the first responders' dispatching center has been developed in a previous FRA sponsored project. This work package will take a step further to expand the previous one-way communication system to a two-way communication system. With the enhanced communication mechanism, critical surveillance images and anomaly detection decision will be shared with the corresponding parties (i.e., the railroads and the first responders) in real-time to provide proactive and rapid response and avoid severe incidents or consequences. Meanwhile, the continuous surveillance and real-time information sharing with the first responders would reduce unnecessary patrol and utilize the limited resource efficiently to better serve the local community.

i-ASAP may be installed at a selected grade crossing provided by the industry partner, CSX, for testing and validation in the field with first responders at the City of Columbia. The anomaly detection and AI decision results will be passed to both the railroad and the first responders through secure channels. Scope Summary:

The effective prevention of trespassing and suicide around grade crossing areas, and more broadly at locations along track segments, heavily relies on two factors: processing of the vision information and identification of abnormal behavior/situation in real time. Therefore, i-ASAP has been developed for continuous, real-time monitoring and recognition based on advanced computer vision and image analysis, artificial intelligence (AI), edge computing, and information sharing with both local law enforcement and railroads through secure communication channels. FIG. 1 illustrates the concept of the i-ASAP platform, which consists of three key modules, including:

Module I 102: AI-based Anomaly Detection Software. The practical effectiveness of deep learning approaches for computer vision has become widely accepted in the research community and industry and has largely been driven by the exceptional performance of convolutional neural networks (CNNs) in end-to-end feature learning and task-specific optimization for image-based problems. To tackle the problem of abnormal event detection at railroad crossings, the current disclosure leverages extensive experience developing and applying CNNs for video processing, and will adapt state-of-the-art methodologies to perform autonomous, high-confidence decision-making for law enforcement and railroad officials. Specifically, the current disclosure has adopted the methodology described in Liu, W., et al. Future frame prediction for anomaly detection a new baseline. in Proceedings of the IEEE Conference on Computer Vision and Pattern Recognition. 2018, which employs CNNs to perform future frame prediction as a mechanism for comparing a given scenario with an expectation. The training process for this system will be carried out offline using a high-performance computing workstation and will be deployed in a heterogeneous edge computing device for real-time abnormal event detection. To handle both the spatial and temporal aspects of surveillance video and ensure that the necessary features are extracted for future frame prediction, the system will be composed of two components: a U-Net, see Ronneberger, O., P. Fischer, and T. Brox. U-net: Convolutional networks for biomedical image segmentation, in International Conference on Medical image computing and computer-assisted intervention. 2015. Springer, architecture adapted for next-frame generation and a Flownet, see Fischer, P., et al., Flownet: Learning optical flow with convolutional networks. arXiv preprint arXiv: 1504.06852, 2015, architecture used to enforce motion constraints and preserve temporal coherency between frames. Training the U-Net architecture for accurate next-frame generation requires minimizing intensity and gradient differences between the predicted next frame and the ground truth next frame. This is the core component of the generator's objective function.

Motion constraints are enforced by mapping the predicted next frame and ground truth next frame through a pretrained Flownet and minimizing their optical flow differences. To further increase the quality of next-frame predictions, an adversarial term is integrated into the joint loss formulation. Following the training approach developed by Goodfellow, see Goodfellow, I., et al. Generative adversarial nets. in Advances in neural information processing systems. 2014, a discriminator CNN is added to the system that competes with the generator U-net in a zero-sum game. In an alternating fashion the generator is trained to produce realistic next-frame predictions, and the discriminator is trained to distinguish between real and generated next frames. Adversarial training has shown to dramatically increase the realism of generated images in several domains. To delineate the characteristics of normal and abnormal events in surveillance video using a single quantitative value, a regularity score is computed using Peak Signal to Noise Ratio (PSNR) as an expectation operator. Several case studies on public domain video datasets, such as:
1. The CUHK Avenue dataset, Lu, C., J. Shi, and J. Jia. Abnormal event detection at 150 fps in matlab. in Proceedings of the IEEE international conference on computer vision. 2013.
2. UCSD Pedestrian dataset, see Mahadevan, V., et al. Anomaly detection in crowded scenes. in 2010 IEEE Computer Society Conference on Computer Vision and Pattern Recognition. 2010. IEEE.
3. ShanghaiTech dataset, see Luo, W., W. Liu, and S. Gao. A revisit of sparse coding based anomaly detection in stacked rnn framework. in Proceedings of the IEEE International Conference on Computer Vision. 2017.

have shown that this predictive CNN architecture maximizes the regularity score gap between normal and abnormal events, thus enabling state-of-the-art anomaly detection performance.

The current disclosure also provides adapted algorithms and software products developed for military ATR to applications of FRA's interest. In an effort supporting the National Air and Space Intelligence Center (NASIC), a novel 3D CNN was designed for end-to-end spatiotemporal feature learning and moving target detection in highly cluttered, wide field of view (WFOV) Space-Based Infrared (SBIR) video. X

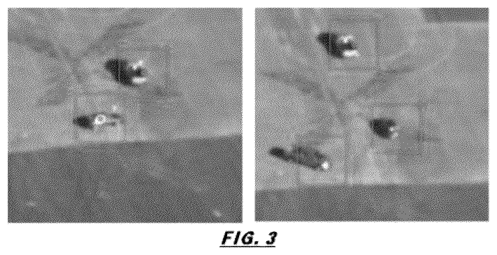

FIG. 2 illustrates results of the current disclosure to identify moving targets in SBIR videos, which are typically much smaller and more challenging to detect than those at grade crossings. Given an unprocessed video clip and frame-of-interest (FIG. 2 at a), the trained convolutional layers progressively extract both locations and directions of moving targets (FIG. 2 at b) and ultimately completely suppress background and enhance target signatures at the output layer (FIG. 2 at c). In another effort, the current disclosure utilized feature detectors and optical flow patterns (Lucas-Kanade method, see Patel, D. and S. Upadhyay, Optical flow measurement using lucas kanade method. International Journal of Computer Applications, 2013. 61 (10): p. 6-102) for video tracking. FIG. 3 shows two airborne video frames where multiple vehicles are being tracked.

### Module II 104: Image Acquisition and Edge Computing Hardware

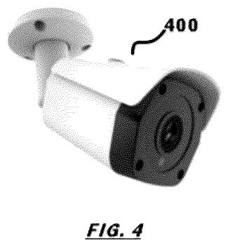

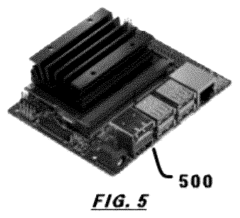

To enable in-situ image analysis and AI inference using the algorithm described above, an appropriate edge computing platform and integration strategy have been selected and developed leveraging our prior experience. The key constraints effecting the hardware configuration and edge computing strategy for i-ASAP are continuous monitoring, real-time analytics, and low Size, Weight, Power, and Cost (SWAP-C) requirements for deployment to many railroad crossings. For our hardware configuration, for purposes of example only and not intended to be limiting as other options exist and are hereby incorporated, the current disclosure uses a Honic PoE IP security camera 400 (~$110) and an NVIDIA Jetson Nano computing platform 500 (~$100) as shown in FIG. 4 and FIG. 5, respectively.

The Honic IP camera 400 is connected to the Jetson Nano 500 via the Jetson's Gigabit Ethernet port and stream full HD (1080p) video at 30 frames per second. Using Ethernet connectivity allows for more flexible configuration at railroad crossings, additional camera inputs if a network switch is employed, and efficient continuous streaming of video around-the-clock. By leveraging the Jetson Nano's CPU/GPU architecture in conjunction with GPU-accelerated libraries and accelerated image encoding and decoding, the current disclosure can perform deep neural network inference efficiently in real-time on the IP sensor stream. In contrast to the heavy computing requirements of the offline deep neural network training process, deploying the trained system, i.e., integrated U-net and Flownet architectures, requires minimal resources and can be accomplished solely on the Jetson Nano. The 4 GB of shared CPU/GPU onboard the Jetson Nano provides plenty of space for model and persistent data, and the 128-core Maxwell GPU can efficiently handle the CNN operations in a highly parallel manner. All of these computational resources are contained within a very small System on a Module (SOM) that is embedded in a development board with a form factor of 3.93 in ×3.27 in×1.14 in, and when the system is running at peak utilization, the platform draws less than 10W of power.

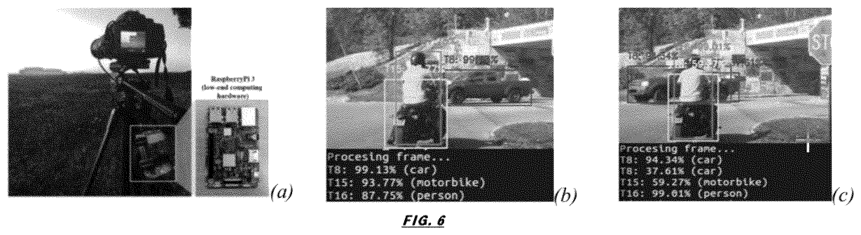

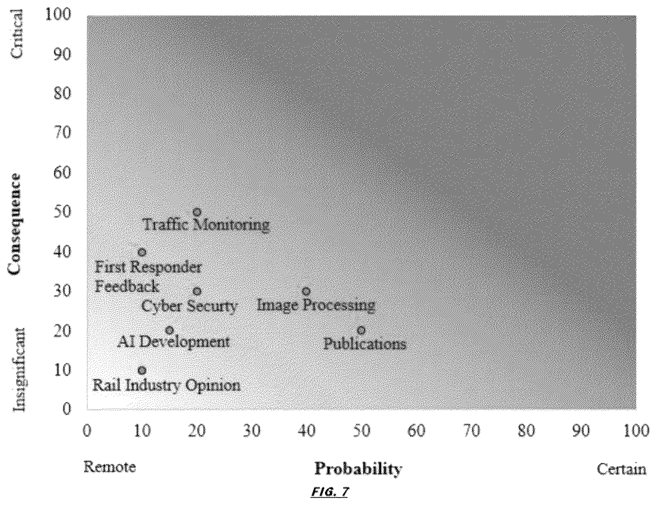

The inventors have extensive experience training deep neural networks and deploying them on resource-constrained hardware. In an Army-sponsored project, the inventors trained a deep CNN to process long, multivariate sensor streams and successfully deployed it to an NVIDIA Jetson TX2 for demonstration. In another effort, the inventors have trained and evaluated a number of cutting-edge deep neural networks for efficient object detection and recognition in video. FIG. 6 at a shows an example of one of our integrated software-hardware systems for deployment and testing of CNN-based Automated Target Recognition (ATR) models. The Raspberry Pi 3 was chosen as a low-end computing platform (~$28) for initial field experiments because of its small size (3.37 in x 2.22 in), low power consumption (1.2W), and limited computing resources (1 GB RAM and 1.2 GHz ARM processor). FIG. 6 at b and c illustrates example imagery with overlaid predicted bounding boxes and class assignments generated by a CNN model running in near real-time on the RaspberryPi. Even while operating in a high-clutter environment, e.g. graffiti, shrubbery, the ATR system was able to recognize foreground objects-of-interest. Each visible segment of the passing truck, even with significant target overlap, was correctly classified and distinguished from the biker. These results convincingly verify the potential of developing and deploying deep neural networks for video analysis in a resource-limited environment for i-ASAP.

Module III 106: Active Information Sharing (with relevant parties). Once the suspicious behavior or abnormal situation has been identified, i-ASAP will actively share the information with involved parties, such as the local law enforcement and railroad dispatch center, through automated text messages specified by the end users. Depending on the urgency of the situation, i-ASAP can also broadcast alarms to the nearby locomotives through radio signals on the railroad communication channels specified by the railroads. This will only utilize existing communication channels without additional equipment from the end users and can reduce redundant information and prevent message jamming. FIG. 4 shows a Honic PoE IP security camera. FIG. 5 shows a NVIDIA Jetson Nano development kit. FIG. 6 shows a CNN-based target classification: (a) vehicle with top five predicted classes; and (b) vehicle and human classification with overlaid detection.

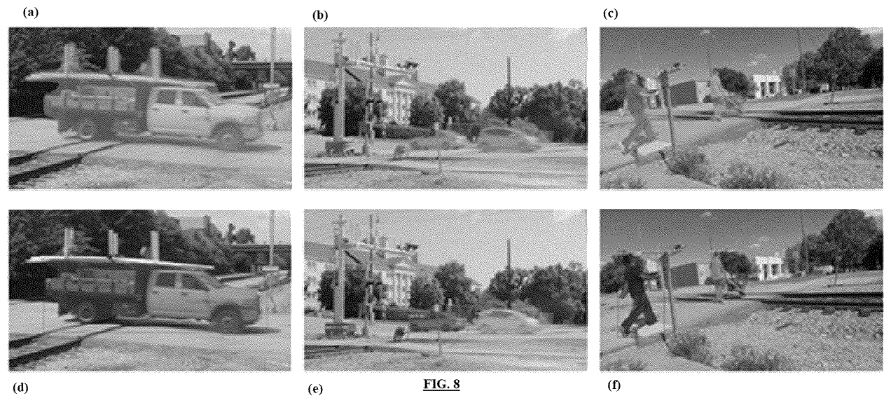

The risk of development of the proposed i-ASAP is very low while the benefit for advancing grade crossing safety is exceedingly high. A risk assessment is shown in the Excel graph below (see FIG. 7). Areas of risk (and mitigation plans) include the following:
Challenges in identifying and obtaining sufficient traffic and pedestrian database at the crossing, because the database largely depends on the crossing itself and the traffic conditions. As a solution, the current disclosure we will perform image acquisition to enrich the varieties of any associated databases.
Image quality is low with low-end camera. As such, the solution is to perform data cleaning and other advanced image processing methods as necessary but in a computationally efficient manner to enhance the effective information extracted from images.
The key factors for different crossings could change and may need several iterations to bring the process to completion. As a solution, we will combine similar sections of tracks as needed during analysis.
Impediments to industrial practices could present barriers. One solution will be to engage stakeholders and committees early and often. In addition, a beta version of the developed system will be integrated and tested with CSX prior to releasing to the market.

This disclosure provides a portable railroad crossing monitoring system based on artificial intelligence and image processing technology. The YOLOv8-FG model, an enhanced version of the YOLOv8 model, is specifically designed for real-time foreground detection at railroad crossings. The YOLOv8-FG model can simultaneously perform detection, segmentation, classification, and tracking, ensuring comprehensive monitoring of non-compliant objects and unauthorized activities within railroad areas. A cost-effective hardware system has also been developed for deployment. Real-time testing has demonstrated the model's effectiveness, confirming its suitability for deployment on edge computing devices. This makes YOLOv8-FG a promising tool for significantly enhancing safety and security at railroad crossings, addressing the limitations of current systems, and ultimately contributing to a proactive approach to railroad crossing management.

While these earlier networks can successfully detect objects they were trained to recognize, they often struggle with items not included during model training. For instance, networks designed for pedestrian detection might fail to identify vehicles, and while some object detectors can recognize pedestrians and vehicles, they may overlook obstacles like fallen trees (He, 2017). The unpredictable nature of intruding or trespassing objects-which can range from animals and dropped parcels to collapsed catenary and other unexpected items, in addition to vehicles and pedestrians-poses a substantial challenge, as the cause of an accident is often unforeseen.

Furthermore, most early object detection models were developed on servers with high-performance GPUs and a consistent power supply. To the inventors' knowledge, few models have been specifically designed for field deployment, considering computing resources and power supply constraints. This gap underscores the need to develop robust, adaptable CNN models capable of operating effectively within the limitations of field deployment environments.

To tackle object detection challenges in rail crossing monitoring, this disclosure provides an enhanced version of the YOLOv8 model (Ultralytics, 2023), named YOLOv8-FG, specifically developed for foreground detection. The YOLOv8-FG model is intricately designed to handle multiple tasks simultaneously-foreground detection, segmentation, classification, and tracking. This comprehensive approach ensures a more accurate and efficient monitoring system that identifies and responds to non-compliant objects or unauthorized activities within the railroad area.

Additionally, real-time testing of the YOLOv8-FG model has demonstrated its feasibility and effectiveness. These tests confirm the model's suitability for deployment on edge computing devices, offering a robust solution that leverages the advantages of advanced AI capabilities while accommodating the limitations of field deployment environments, such as restricted computing resources and power supply. This adaptability makes it a promising tool for enhancing safety and security at railroad crossings.

The safety of railway grade crossings has been a perennial concern and an intense research focus. However, the advent of artificial intelligence (AI) and machine learning technologies have injected a fresh impetus and research trajectory in this field. For instance, Zaman et al. (2019) employed Mask R-CNN to detect railroad intrusion events. Concurrently, Sikora et al. (2020) introduced a railway crossing surveillance system, utilizing YOLO and SSD networks to monitor vehicles and pedestrians. Building on the principle of swift object detection, Guan et al. (2022) devised a high-speed obstacle detection algorithm for railway images based on a streamlined YOLO-Tiny network and a swift region proposal. In parallel, Wang & Yu (2021) unveiled an innovative neural network rooted in the SSD framework for railway intrusion detection. Additionally, Zhang et al. (2022) developed a YOLO-based framework for automatically identifying railroad trespassing incidents. However, it is vital to acknowledge that these methodologies predominantly leverage object detection techniques for rail-related monitoring. While they deliver essential functions for intrusion detection, they are fundamentally basic and do not provide an all-encompassing solution for rail crossing monitoring.

Object detection refers to identifying and localizing instances of specific object classes within an image or a video frame (He, 2017). This technique primarily involves using deep learning algorithms and convolutional neural networks to recognize and classify objects, such as cars, pedestrians, or animals, and determine their boundaries or locations within the scene. On the other hand, foreground detection, also known as change detection or background subtraction, is a technique that aims to distinguish the moving elements, referred to as the foreground, from the static scene, referred to as the background (Varadarajan, 2015). This is achieved by analyzing the differences between consecutive frames in a video sequence and identifying the regions with significant changes, which are then classified as foregrounds.

The clear illustration of the differences between object detection and foreground detection in FIG. 8 shows that while object detection, see FIG. 8 at (a), (b), and (c) can recognize and classify common objects, such as pedestrians and cars, providing a more detailed understanding of the scene, it may encounter difficulties, see FIG. 8 at (d), (e), and (f), when faced with uncommon or irregular objects, such as pipes, a squatting person, or a wheelbarrow. This can lead to false-negative errors, where the object is not detected, or false-positive errors, where background objects are mistakenly identified as foreground objects.

On the other hand, Foreground segmentation does not classify objects with limited categories but detects all the outliers shown within a scenery as the Region of Interest (ROI). Therefore, foreground segmentation is particularly useful in applications where it is essential to detect and monitor the movement of objects within a given environment, such as in traffic monitoring or intrusion detection systems. This could be ideal for crossing monitoring because it could identify all the static and moving outliers within the railroad crossing area.

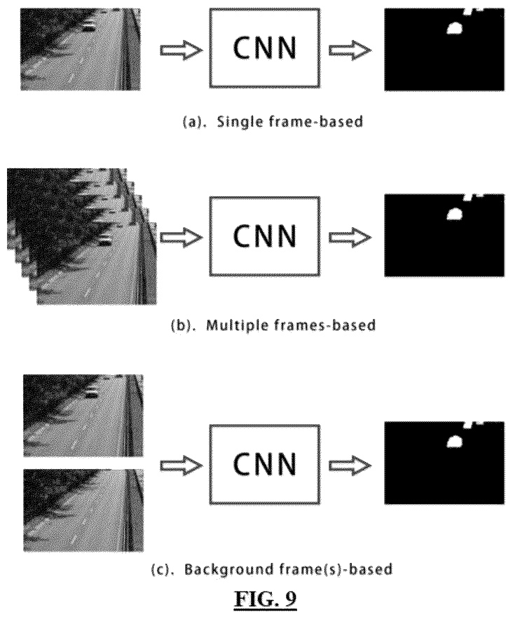

Previous research has utilized CNNs to segment video frames into foreground and background regions. As illustrated in FIG. 9, based on the type of network input, these methodologies can be classified into three categories: (a) single-frame-based models, (b) multiple-frame-based models, and (c) background-frame(s) based models.

Single-frame-based models operate by analyzing each frame independently to detect foreground elements. This approach is characterized by its simplicity and speed, which makes it particularly useful in scenarios where computational resources are limited or rapid response is crucial. The multi-scale architecture proposed by Lim and Keles (2020) exemplifies this method's ability to handle varying object scales within a frame. Rahmon et al. (2021) further enhanced the capability of single-frame models by integrating motion analysis through a motion U-Net, which combines the traditional algorithms of foreground segmentation with CNNs to improve motion detection accuracy. Xu et al. (2022) introduced an innovative approach in this category with their cascaded feature-mask fusion network, designed to refine the segmentation process by consecutively processing features and masks within a single frame. This method shows potential in enhancing detail recognition, though, like most single-frame models, it faces limitations when applied to unfamiliar scenes. The model's training on specific types of scenes can significantly decrease performance when confronted with new or varied environments, highlighting a crucial drawback of the single-frame approach.

Expanding on the idea of temporal context, multiple-frames-based models utilize the current frame and surrounding frames (either past or future) to predict foreground segments. This method helps understand motion and temporal consistency, which single-frame models often miss. For instance, Yang et al. (2017) demonstrated using a Fully Convolutional Network (FCN) that processes multiple frames to detect dynamic changes more effectively. Hou et al. (2021) introduced a lightweight, fast 3D CNN that simultaneously processes video sequences to capture temporal and spatial dynamics, providing a robust framework for environments where quick adaptation to changes is necessary. Meanwhile, Valipour et al. (2017) proposed a recurrent CNN approach, using the network's hidden states to maintain a memory of previous frames, thus enhancing the continuity in foreground detection. These models are generally more flexible in new scenes but might struggle with detecting stationary objects that do not vary across multiple frames, posing a challenge in scenarios where such objects could be critical.

The third category involves models that use a background reference frame(s) to compare with current frames to detect foreground objects. This approach is highly effective in stable environments where the background remains mostly unchanged. Lin et al. (2018) employed an FCN that uses both the generated background and the current frame for segmentation, utilizing advanced background modeling techniques like SuBSENSE (St-Charles, 2014) to adaptively update the background in light of environmental changes. Vijayana et al. (2021) enhanced the recognition rate of moving objects by integrating optical flow analysis with background reference, allowing for a more dynamic understanding of object movements relative to the static background. These models are particularly adept at handling scenarios with a consistent background but may require high-quality background frames to maintain accuracy, a factor that can be limiting in environments with variable backgrounds.

Given the specific needs of rail crossing environments—where safety is paramount, and the ability to detect static and moving objects is crucial-background frame(s)-based models offer a compelling solution. Rail crossings typically present a relatively stable background, making it easier to implement background frame(s)-based methods effectively. By employing traditional and advanced techniques for background generation, these models can swiftly create accurate background frames, thus ensuring consistent performance without the need for frequent retraining.

The SuBSENSE algorithm (St-Charles, 2014), as employed in the YOLOv8-FG model for foreground segmentation and background generation, is a sophisticated tool designed to tackle the complexities of dynamic video environments. This highly adaptive method uses advanced techniques to discern between foreground and background elements in each video frame it processes.

Upon receiving a video frame, the SuBSENSE algorithm meticulously analyzes every pixel. It employs a dual-criterion approach to determine the nature of each pixel. The first criterion involves evaluating the pixel's RGB color values, which provide direct color information about the pixel. The second criterion uses Local Binary Similarity Pattern (LBSP) features, a form of texture descriptor that captures the pixel's local spatial pattern and contrast features. These two data points together allow SuBSENSE to perform a robust comparison between the current pixel and a library of background images.

The background library is a central component of SuBSENSE's operation. It contains 50 background images, which are continuously updated and maintained to reflect the dynamic nature of the video environment. When deciding whether a pixel belongs to the background or the foreground, the algorithm checks for consensus among these images. If at least two background images agree that a pixel should be classified as part of the background, then it is deemed a background pixel. If not, it is classified as foreground.

The update mechanism of the background library is conservative yet effectively adaptive, employing a stochastic, two-step approach. When a pixel is confirmed as part of the background, one of the background images in the library has a chance (determined by the hyperparameter T) of updating that specific pixel to match the current frame's pixel. Furthermore, this update process may extend to one of the neighboring pixels as well, thus allowing the background model to adapt gradually and smoothly over time.

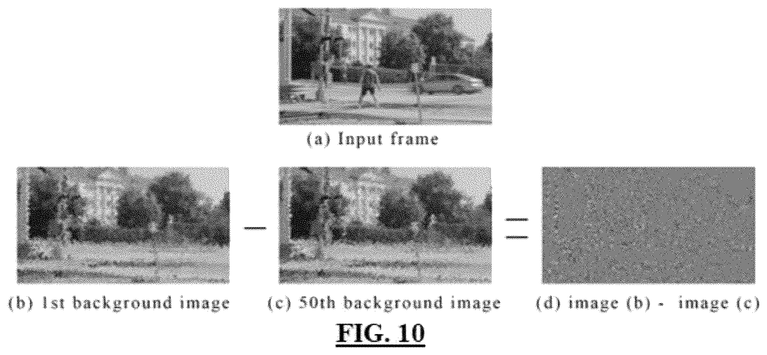

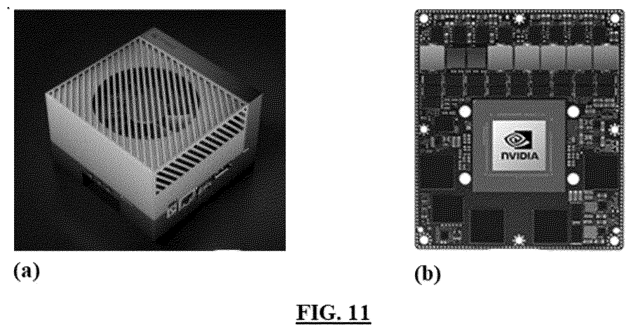

This stochastic updating process results in the generated background images often appearing blurry, as they represent a probabilistic consensus of many frames over time rather than a sharp snapshot of any single moment. To illustrate the subtle changes that occur in the background library, FIG. 10 compares the first and the last generated background images. Given the difficulty in discerning differences between these images with the naked eye due to their blurred characteristics, a differential image is created by subtracting these two background images, see FIG. 10 at (d). This differential image effectively highlights the small, often imperceptible changes, providing a clearer understanding of how the background evolves in response to changes within the video stream.

The AGX Orin, produced by Nvidia and depicted in FIG. 11 at (a), is an edge device designed for model inferencing that showcases a compact and highly portable form. Measuring just 100 mm×87 mm×70 mm and weighing only 918 grams, it is specifically tailored for mobile or space-constrained environments where size and weight are critical considerations. This device is powered by a 12-core ARM CPU equipped with a robust GPU containing 2048 CUDA and 64 tensor cores. These components are built on the advanced Ampere architecture and operate at a frequency of 1.3 GHZ, delivering a potent combination of efficiency and computing power. The AGX Orin achieves computational capabilities of up to 5.3 TFLOPS, which is significant for edge computing applications that require intensive data processing. Additionally, the device is designed to operate within a power envelope of 30 watts under normal conditions and can go up to 60 watts at peak performance. FIG. 11 at (b) shows the Nvidia AGX Orin Core.

In FIG. 12, the current disclosure showcases the sophisticated architecture of YOLOv8-FG, a cutting-edge version of the renowned YOLOv8 network (Ultralytics, 2023). This advanced iteration introduces a novel component, the input head, designed to enhance the network's ability to identify and discern foreground objects within complex visual scenes. The primary innovation of the YOLOv8-FG model lies in its ability to effectively compare differences between current frames and static background frames, thereby isolating dynamic or static objects that constitute the immediate foreground. This capability is crucial for applications where precisely detecting moving or relevant objects against a cluttered or changing background is essential.

The input head's functionality is supported by sophisticated algorithms that analyze the temporal and spatial variations between consecutive frames, allowing YOLOv8-FG to dynamically differentiate between foreground elements and the background scenery. This differentiation is vital in reducing both false-negative errors, where a foreground object is mistakenly overlooked, and false-positive errors, where objects in the background are incorrectly classified as being in the foreground. By mitigating these errors, YOLOv8-FG significantly enhances the accuracy and reliability of object detection in diverse environments.

Moreover, YOLOv8-FG integrates the capabilities of the Contrastive Language-Image Pre-training (CLIP) (Radford, 2021) and Deep-SORT (Wojke, 2017) algorithms into its architecture, further extending its functionality. The CLIP algorithm leverages vast amounts of textual and visual data to understand and classify images in a manner that mimics human visual and cognitive abilities. This integration allows YOLOv8-FG to not only detect but also interpret and classify foreground objects in a context-aware manner, enhancing its applicability in scenarios requiring a nuanced understanding of the scene.

The Deep-SORT algorithm complements this by providing robust tracking capabilities. It employs advanced data association techniques and motion prediction algorithms to track the trajectories of detected objects across successive frames. This feature is particularly beneficial in dynamic scenes where objects are in constant motion, ensuring that the monitoring of target entities remains consistent and reliable throughout the sequence of frames.

A nuanced enhancement is introduced to achieve foreground detection effectively by adding a specialized input head to the established YOLOv8 architecture (Ultralytics, 2023), resulting in the YOLOv8-FG model. This modification allows the model to process both the current video frame and background images simultaneously, setting the stage for accurate foreground detection. The innovative approach involves leveraging the differences between the current frame and the background, which is continually updated using the SuBSENSE algorithm, a robust method for background generation.

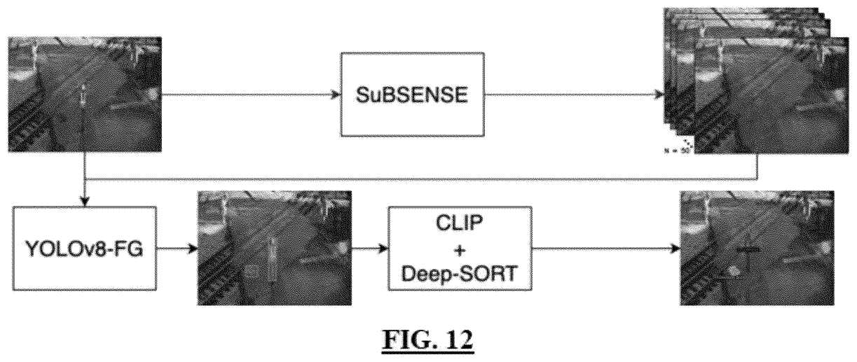

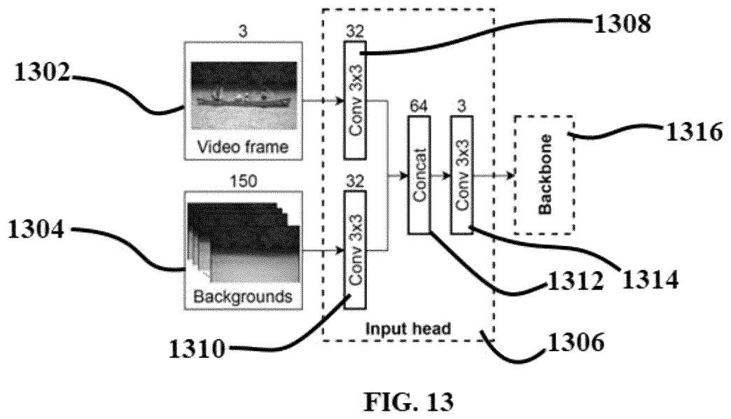

FIG. 13 illustrates the sophisticated structure of the input head 1306, which plays a pivotal role in ensuring the equilibrium of the data inputs. Specifically, the video frame is a standard RGB image with three channels 1302. In contrast, the background images, derived from the SuBSENSE algorithm (St-Charles, 2014), consist of an ensemble of 50 RGB images, cumulatively presenting 150 channels 1304. This vast channel quantity difference could skew the model's attention toward the background, overshadowing the video frame. Such an imbalance might impede the model's ability to discern subtle differences between the foreground and the background, which is crucial for accurate detection.

The input head 1306 is designed to harmonize the weight between the video frame and the background images to counteract this potential bias. It accomplishes this by transforming both types of inputs into feature maps of identical size. The input head features two distinct branches, 1308 and 1310, each with a single convolutional layer. The first branch 1308 processes the input frame, and the second branch 1310 manages the 50 background images. Through these branches, the input frame and the background images are converted into a standardized set of feature maps, each with 32 channels.

Following this conversion, these two sets of feature maps are concatenated to form a combined 64-channel feature map 1312. This concatenated feature map undergoes a final convolutional transformation to compress it into a 3-channel output 1314. While retaining essential information, this compressed output is designed to be compatible with the backbone 1316 of the YOLOv8 architecture without requiring further modifications. This elegant solution maintains the integrity and efficiency of the original YOLOv8 design and enhances its capability to perform foreground detection with high precision. This approach ensures that the YOLOv8-FG model remains robust and adaptable, capable of handling diverse and dynamic visual environments.

YOLOv8-FG is built upon the YOLOv8, a significant enhancement from its predecessor, YOLOv5 (Jocher, 2022). Based on the official documentation and source code, key upgrades in YOLOv8 include a new backbone network and an innovative anchor-free detection head.

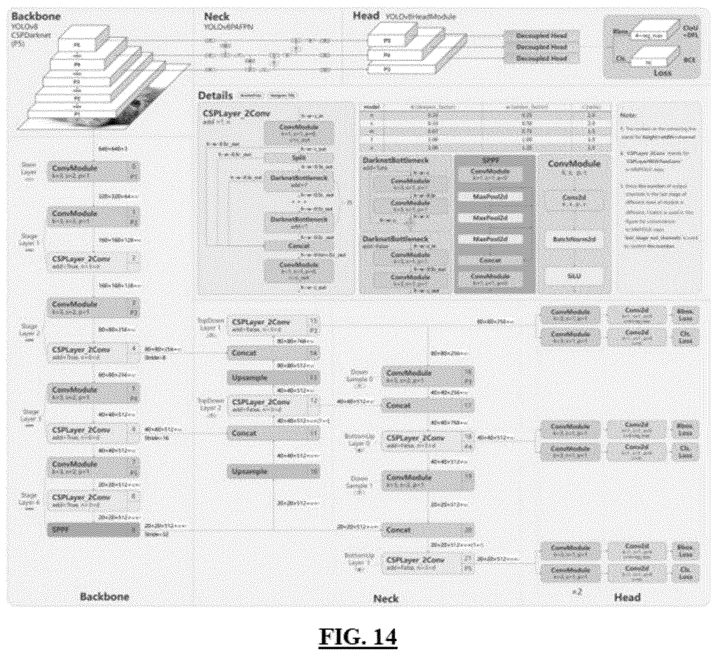

As shown in FIG. 14, the backbone of YOLOv8-FG has seen a transformative update, most notably by replacing the C3 modules with the novel C2f modules. This new configuration leverages principles from the Efficient Layer Aggregation Network (ELAN), significantly enhancing the model's efficiency and performance. The introduction of C2f modules results in improved gradient information flow through the network, reducing the overall parameter count and boosting the computational efficiency. These improvements yield a quicker model and enhance its performance by streamlining the detection process, leading to faster real-time applications.

The Spatial Pyramid Pooling Fusion (SPPF) module in YOLOv8 remains a critical component inherited from YOLOv5. The SPPF module, which builds upon the traditional Spatial Pyramid Pooling (SPP) design, allows the network to handle variable input image sizes more efficiently. This flexibility greatly enhances the model's generalization capabilities across different visual contexts, making it robust against various scales and dimensions of input data. The optimization of processing speed within the SPPF module ensures that the model can perform efficiently without compromising detection accuracy.

A major innovation in YOLOv8 is overhauling the detection head, transitioning from an anchor-based approach used in YOLOv5 to a new anchor-free methodology. This paradigm shift allows each pixel in an image to directly predict the coordinates of bounding boxes without relying on predefined anchor boxes. This change simplifies the learning process and reduces the complexity of the model. Additionally, by separating the box prediction and classification tasks into two distinct branches, YOLOv8 minimizes the conflict in learning these two different tasks simultaneously, thus enhancing the overall effectiveness and accuracy of the model.

Empowering the foreground detection capacity to YOLOv8-FG deprives its object classification feature, which is the fundamental nature of object detection. However, as a rail crossing monitoring algorithm, it is essential to know the types of foreground objects to distinguish if they are trains or other objects like cars, pedestrians, etc. The train will not trigger the alarm, but other objects will if they stay too long in the rail crossing area. Therefore, this study further integrates CLIP (Radford, 2021) to classify the detected foreground objects. The algorithm can accurately identify objects in the monitored area by leveraging CLIP's robust image classification capabilities. This approach ensures that trains passing through the crossing do not trigger unnecessary alarms while other objects that pose potential risks are effectively detected and managed.

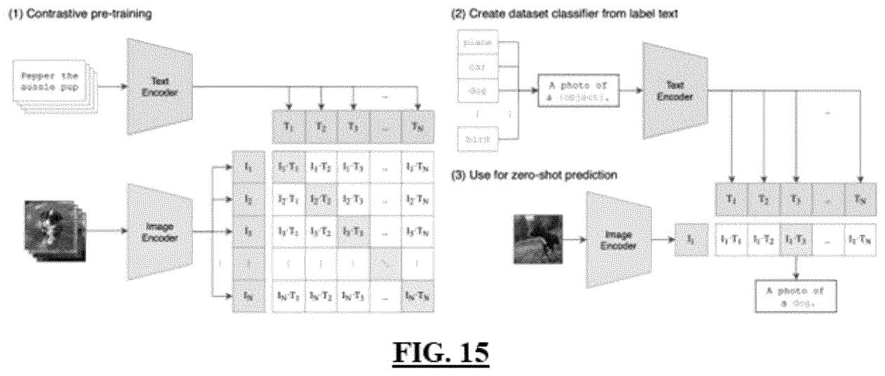

Contrastive Language-Image Pre-training (CLIP) is a model developed by OpenAI that leverages large-scale pre-training to learn visual concepts from natural language descriptions. As shown in FIG. 15, the fundamental idea behind CLIP is to use contrastive learning, which aims to associate images and their corresponding textual descriptions in a shared latent space. This approach allows CLIP to perform various visual classification tasks without task-specific fine-tuning.

One of the significant advantages of CLIP is its ability to perform zero-shot learning, especially in open-world image classification scenarios. Zero-shot learning refers to the model's capability to recognize and classify images from categories it has never seen during training. The model encounters a diverse and potentially infinite set of categories in open-world image classification. Traditional models struggle with such tasks because they require extensive labeled data for each category. However, CLIP overcomes this limitation by leveraging its learned associations between images and textual descriptions.

As shown in FIG. 15, in practical terms, when given an image, CLIP can generate an embedding for it using the image encoder. Simultaneously, the model can generate embeddings from their textual descriptions using the text encoder for a set of potential categories. By comparing the image embedding with the category embeddings, the model can identify the category with the highest similarity, effectively classifying the image without needing specific training on those categories. This ability to generalize from textual descriptions makes CLIP particularly powerful for open-world classification, where it can adapt to new categories on the fly.

YOLOv8-FG and YOLOv8 are foreground and object detectors, and they are designed to work on a per-frame basis, detecting objects within individual video frames. However, one of the core functions of this study is to identify outliers that remain in the rail crossing area for extended periods. It is essential to employ a tracking algorithm that can consistently associate the same objects across successive frames to accomplish this. This tracking capability allows for monitoring objects over time, thereby enabling the detection of those that linger in the rail crossing area longer than expected, which is crucial for identifying potential hazards or anomalies.

Deep SORT is a sophisticated tracking algorithm used primarily in computer vision tasks to track multiple objects in videos or image sequences (Wojke, 2017). It's an extension of the SORT algorithm incorporating deep learning features for better object recognition and tracking.

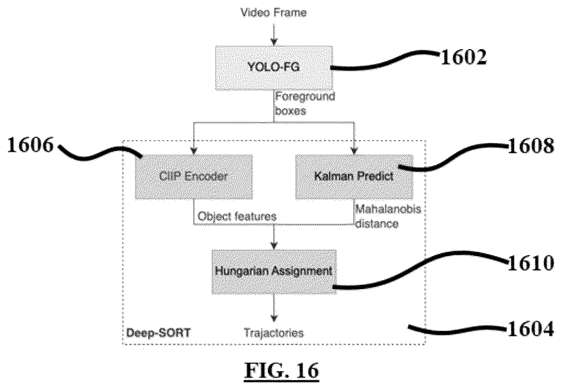

As shown in FIG. 16, once YOLOv8-FG detects the foreground objects 1602, Deep SORT extracts deep features from these bounding boxes 1604. Instead of using the raw pixel values, it passes the cropped regions corresponding to each bounding box through a deep neural network (e.g., ResNet) to obtain a high-dimensional feature vector for each object. Given that the CLIP model was already employed for object classification in the previous section, we can directly utilize the feature vectors produced by the CLIP encoder 1606. This integration eliminates the need for an additional network for feature extraction.

Once these features are obtained, Deep SORT employs a data association algorithm that integrates the Kalman filter 1608-a mathematical technique used for estimating the state of a linear dynamic system from a series of incomplete and noisy measurements. The Kalman filter is adept at predicting each object's future state (position and velocity) based on its previously known trajectory. This prediction is crucial for handling frame-to-frame associations under motion.

With the predicted positions in hand, the next step in the Deep SORT pipeline involves associating these predicted tracks with new detections in the current frame. The algorithm utilizes the Hungarian algorithm 1610, an optimization approach that solves the assignment problem in polynomial time. The Hungarian algorithm compares the predicted tracks to new detections by considering their spatial proximity, as measured by the Intersection over Union (IoU) of their bounding boxes, and their appearance similarity, as quantified by the cosine distance between their feature vectors.

Combining these two metrics-IoU for spatial alignment and feature vector similarity for appearance-ensures that the tracking is accurate and resistant to errors caused by occlusion or similar-looking objects entering the scene. This robust method of track-detection association allows Deep SORT to maintain consistent object identities across frames, even in complex, dynamic environments.

In the context of advancing real-time object detection technologies, the YOLOv8-FG model presents a complex integration of techniques to enhance foreground detection, classification, and tracking. This model differs significantly from its predecessor, YOLOv8, by incorporating sophisticated modules such as Subsense, CLIP, and Deep-SORT, each adding a layer of computational demands which, in turn, contribute to the potential bottleneck in processing speed when deployed in a sequential inference framework.

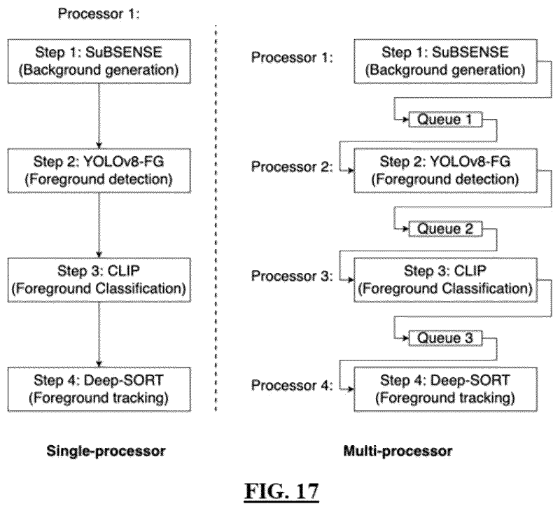

In a traditional single-threaded pipeline, a singular processing unit is responsible for executing all tasks sequentially. As depicted in FIG. 17, this process inherently leads to an accumulation of latency as each task must wait for the previous one to complete before it can begin. This setup, although straightforward, is not optimized for speed, especially in applications requiring real-time processing, such as autonomous driving systems or advanced surveillance technologies.

To counter these challenges, our study proposes a restructured approach to the inference pipeline of YOLOv8-FG by leveraging a multi-processor model, see FIG. 17. This model utilizes the inherent capabilities of multi-core processing platforms, organizing the workflow into a parallel processing architecture. Here, different stages of the pipeline—namely foreground detection, object classification, and motion tracking—are assigned to separate processors.

Each processor operates independently, processing its designated task simultaneously with others. This division of labor is coordinated through queues, facilitating data transfer between processors. These queues function akin to conveyor belts in an industrial assembly line, where each processor or ‘worker’ is responsible for a specific segment of the overall task. The overall system latency is significantly reduced by enabling each pipeline segment to operate concurrently.

Furthermore, this multi-processor approach not only minimizes idle time but also ensures that the utilization of CPU resources is maximized. The performance of such a pipeline is constrained primarily by the slowest segment-often a factor of the computational complexity of a particular task and the efficiency of data transfer between processors. Nevertheless, even with these constraints, the multi-processor model demonstrates a marked improvement in processing speed compared to the traditional single-threaded approach.

The YOLOv8-FG is tailored for foreground detection, segmentation, classification, and tracking, but the limited availability of comprehensive datasets currently constrains its evaluation. In particular, the model relies on the CDnet 2014 (Wang, 2014) dataset for testing purposes.

The CDnet 2014 dataset is a widely used benchmark in change detection and foreground segmentation. Despite its richness in terms of content, CDnet 2014 only provides ground-truth data for foreground segmentation, lacking category and track ID information for each instance. Consequently, this limitation prevents a thorough evaluation of the Hybrid-RCNN's mask head, and only the F-Measure metric can be used for performance assessment.

To showcase the capabilities of the CLIP and Deep-SORT, we will provide demonstrations and qualitative results to highlight the YOLOv8-FG's ability to accurately identify and track multiple objects of different categories in complex scenes.

As shown in Eq. 1, F-Measure is the harmonic mean of precision and recall; a high F-Measure reflects high precision and recall. Precision is the percentage of detected foreground pixels correctly classified, and it can evaluate the anti-noise ability of the network, as shown in Eq. 2. Recall is the percentage of true foreground pixels classified correctly, and it can estimate the foreground recognition rate of the network, as shown in Eq. 3.

$$F - Measure = \frac{2 \times Precision \text{?} Recall}{Precision + Recall} , \qquad ( 1 )$$

$$Precision = \frac{T P}{T P + F P} , \qquad ( 2 )$$

$$Recall = \frac{T P}{T P + F N} , \qquad ( 3 )$$

where TP, FP, and FN are the numbers of true-positive, false-positive, and false-negative pixels, respectively.

The experiments conducted on the CDnet 2014 dataset aim to evaluate the performance of the proposed YOLOv8-FG model for foreground segmentation in various challenging scenarios. The YOLOv8-FG, a state-of-the-art deep learning model, is trained using a 7:3 split of the dataset-70% of the frames are utilized for training purposes while the remaining 30% serve as the test set. The CDnet 2014 dataset is an exemplary choice for testing such models due to its diverse array of video environments and scenarios, ranging from low-light conditions to dynamic weather situations, which effectively validate the robustness and adaptability of the YOLOv8-FG model.

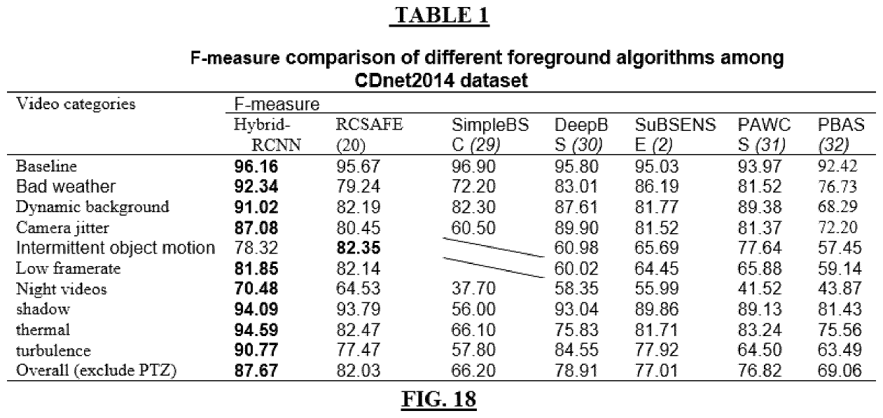

In the evaluation process, the foreground segmentation results of the proposed YOLOv8-FG model are compared with those from several other leading algorithms. These include contemporary deep learning models like RCSAFE, SimpleBSC, and DeepBS, and classical image processing methods such as SuBSENSE, PAWCS, and PBAS. In these comparisons, detailed in Table 1, see FIG. 18, the YOLOv8-FG model distinguishes itself by achieving the highest F-measure, a robust metric of accuracy, reaching an impressive 87.67%. This statistic not only underscores the efficacy of the YOLOv8-FG in foreground segmentation but also highlights its superiority over existing methods.

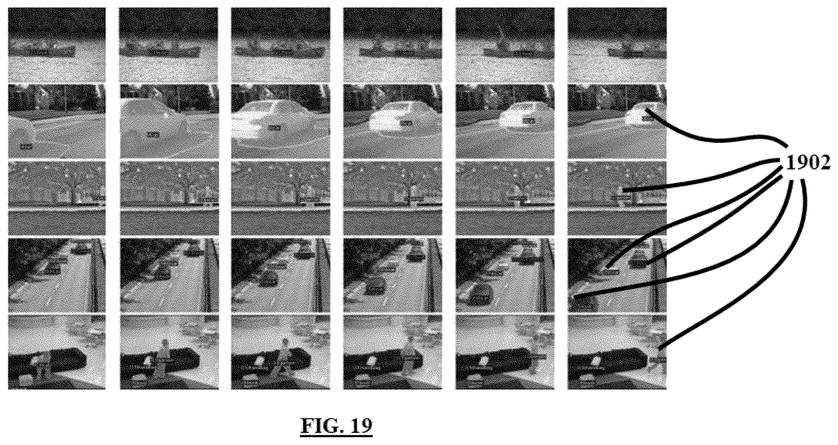

Further demonstrating the capabilities of the YOLOv8-FG model, FIG. 19 presents a series of detection results showcasing the model's effectiveness in real-world applications. Each detected object in the visual results is highlighted by a distinctively colored bounding box 1902, which encapsulates the object's class label and tracking number. These visual aids illustrate the model's remarkable prowess in detecting and segmenting foreground objects from their backgrounds, accurately classifying them into their respective categories, and consistently tracking their movement across frames. This series of results provides a visual proof of the model's operational success and a clear indication of its potential applications in complex environments where accurate and reliable object detection and tracking are crucial.

Optimizing the inference speed of YOLO-FG systems on edge devices such as the Nvidia Jetson AGX Orin is crucial for applications requiring real-time processing and analysis. The Jetson Orin, a compact edge-computing device measuring 110 mm×110 mm×71.65 mm and weighing 918g, is an ideal platform for such tasks due to its robust computing capabilities and energy efficiency. It is powered by a 12-core ARM CPU equipped with 2048 CUDA cores and 64 tensor cores. The device operates with normal and peak power consumptions of 30W and 60W, respectively, balancing performance with energy consumption.

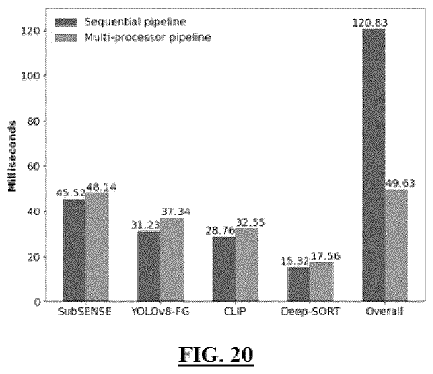

A detailed analysis of the device's performance, as presented in FIG. 20, demonstrates some surprising results when comparing different processing pipelines. The single-threaded CPU pipeline processes tasks sequentially, moving from one processing phase to another. It starts with SubSENSE, progresses through various analysis stages, and ends with Deep-SORT. This pipeline results in a cumulative system latency of 120.82 milliseconds, translating to an inference speed of approximately 8.28 frames per second (FPS). The limitation here is evident as the pipeline does not leverage the multi-core architecture of the CPU, relying instead on a single thread for execution. This approach underutilizes the CPU's capabilities, particularly in multi-core processing and threading, which are essential for optimizing performance in complex computational tasks.

In contrast, the multi-processor pipeline adopts a parallel processing approach. Each pipeline segment is assigned to a separate CPU core, allowing simultaneous operation and significantly reducing overall latency. This methodology maximizes CPU utilization and enhances the system's inference speed by effectively distributing the workload across available resources. The key challenge in a multi-processor pipeline, however, is that its efficiency depends on its slowest segment's performance. In this case, the SubSENSE segment has been identified as the slowest, with a latency of 48.14 milliseconds. Despite this bottleneck, the multi-processor pipeline achieves a reduced overall latency of 49.63 milliseconds and a frame rate of 20 FPS, notably higher by 10 FPS than the sequential pipeline.

This comparative analysis between the sequential and multi-processor pipelines on the Nvidia Jetson AGX Orin highlights the importance of architectural considerations in software design for edge computing devices. By effectively leveraging the multi-core capabilities of the Jetson Orin, the multi-processor pipeline substantially improves performance, demonstrating the potential for real-time processing and analysis in edge-based applications. The insights gained from such analyses are vital for developers and engineers looking to optimize computer vision systems, ensuring that they meet the required accuracy standards and perform efficiently in real-world environments.

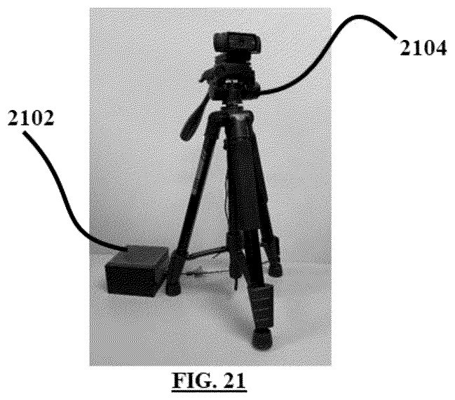

The online testing platform employed for our research experiments incorporates advanced hardware components, specifically a high-performance edge computing unit, the NVIDIA Jetson AGX Orin 2102, and a high-definition Logitech HD Pro Webcam C920 2104. These elements are shown in FIG. 21. The platform's primary hardware, the NVIDIA Jetson AGX Orin 2102, offers robust computational power ideal for running complex machine learning models directly on the edge, essential for real-time processing requirements in field applications.

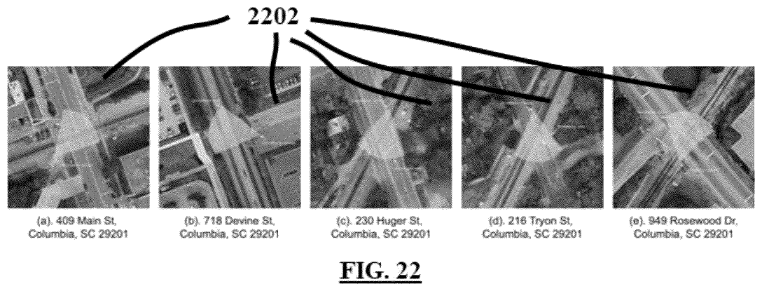

As shown in FIG. 22, field testing of our system was conducted at various locations in Columbia, SC 2202. This diverse array of testing environments provided a broad spectrum of data, helping us assess the system's performance under different environmental conditions. The testing sites were chosen based on their unique characteristics, which included varying traffic patterns, pedestrian activity, and physical obstructions, all of which pose distinct challenges for automated detection systems.

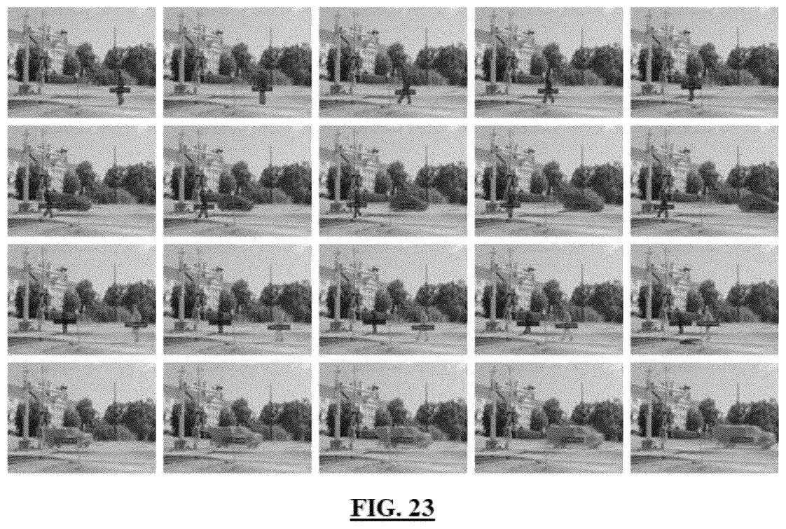

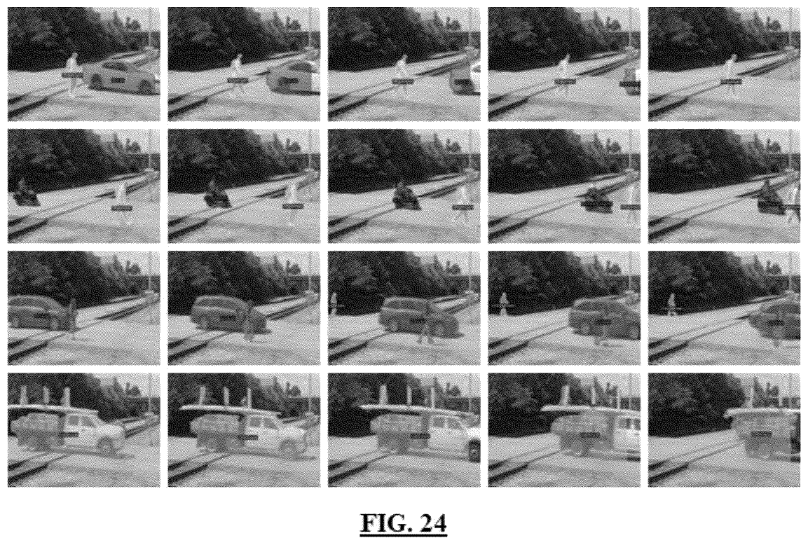

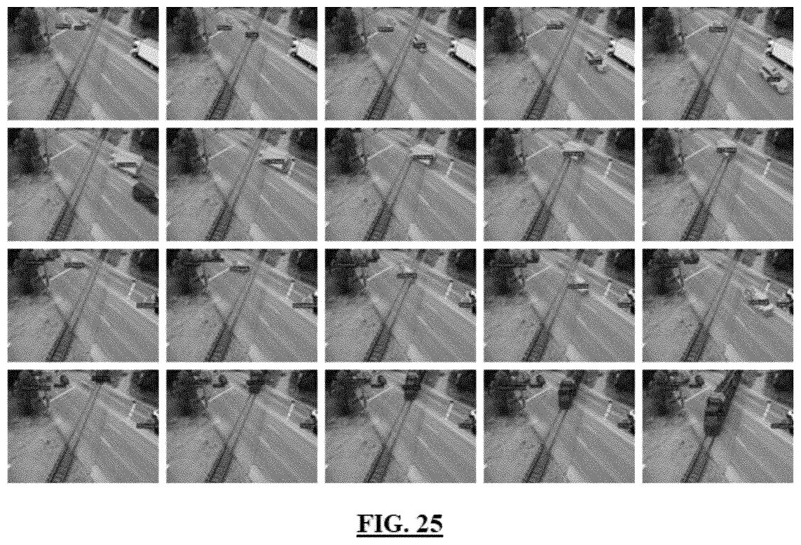

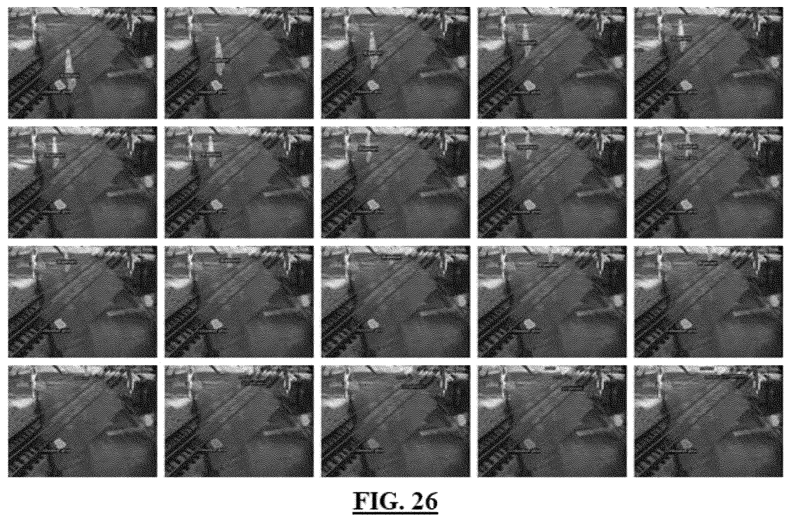

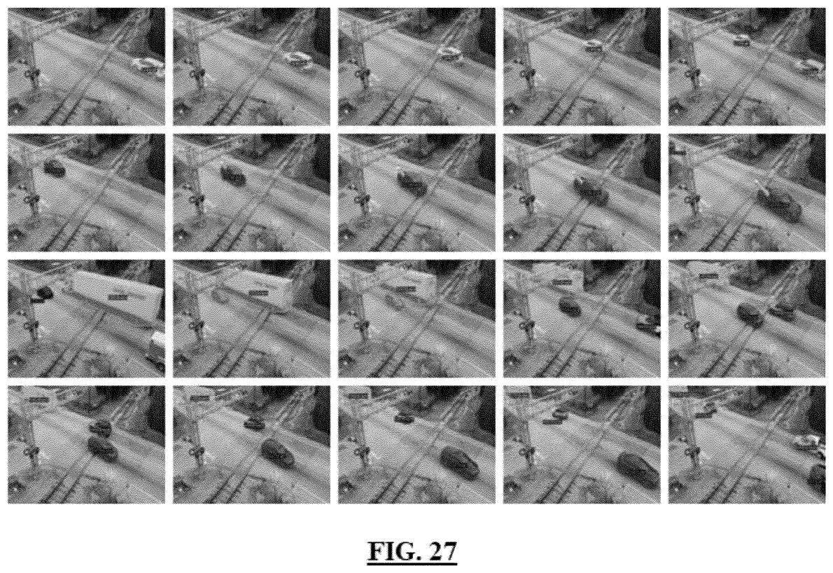

As evidenced in FIG. 23-27, the YOLO-FG system successfully identified an outlier in the rail crossing environment during one of the field tests. This detection is particularly noteworthy because it highlights the system's ability to discern and react to unexpected obstacles or anomalies effectively, thereby underscoring its practical effectiveness and reliability in real-world scenarios. The identified outlier, a temporarily placed construction sign not usually present at the site, was accurately detected and classified by our system, demonstrating its acute sensitivity to environmental changes.

The successful deployment and operation of our system demonstrate its potential in improving safety measures at rail crossings, a critical area of concern for urban transportation safety. This successful application not only validates the robustness of our proposed solution but also sets a precedent for future enhancements and implementations. The results we obtained are promising and pave the way for further research and refinement of the system to address broader safety challenges in rail transport and other related fields. The next steps include scaling the system for broader deployment across multiple cities and integrating additional sensors for enhanced multimodal data collection, which will allow for even more robust and fault-tolerant systems.

In this disclosure, we introduced the novel YOLO-FG model for foreground detection, specifically tailored for railroad crossing monitoring to enhance safety. The proposed method consists of four components: first, the SuBSENSE algorithm generates the background; then, the YOLO-FG model inputs the current frame and background images to detect foreground objects. The CLIP model is employed to classify the detected objects. Finally, the Deep-SORT model tracks and associates the same objects across successive frames. This comprehensive system offers an effective solution for safeguarding the safety and security of railway grade crossings.

Experiments utilizing the CDnet 2014 dataset assess the performance of the YOLOv8-FG model, specifically designed for foreground detection. The YOLOv8-FG model outperforms several leading algorithms, achieving the highest F-measure of 87.67%. This superior performance is demonstrated through example detections, where the model accurately identifies, classifies, and tracks various foreground objects.

This study also optimizes the YOLO-FG system on the Nvidia Jetson AGX Orin for real-time applications. The analysis compares single-threaded and multi-processor pipelines. Using one CPU core, the single-threaded pipeline achieves a latency of 120.82 milliseconds and 8.28 FPS. In contrast, leveraging multiple cores for parallel processing, the multi-processor approach significantly reduces latency to 49.63 milliseconds and increases the frame rate to 20 FPS. This demonstrates multi-core architecture's effectiveness in enhancing performance in edge computing devices.

Field testing at various railroad crossing areas highlights the robust performance of the YOLOv8-FG model in different environments. The model identifies unauthorized or unexpected objects within the railroad crossing area. The effectiveness of Hybrid-RCNN in detecting anomalies and ensuring safety at railroad crossings is evident from its ability to accurately identify and segment objects that are not typically part of the railroad environment. This enhancement in detection capability marks a significant advancement in the application of artificial intelligence for public safety and infrastructure monitoring.

### REFERENCES

FRA. (2019). Highway-Rail Grade Crossings Overview. Retrieved from railroads.dot.gov/program-areas/highway-rail-grade-crossing/highway-rail-grade-crossings-overview
Guan, L., Jia, L., Xie, Z., & Yin, C. (2022). A lightweight framework for obstacle detection in the railway image based on fast region proposal and improved yolo-tiny network. IEEE Transactions on Instrumentation and Measurement, 71, 1-16.
He, K., Gkioxari, G., Dollár, P., & Girshick, R. (2017). Mask r-cnn. In Proceedings of the IEEE international conference on computer vision (pp. 2961-2969).
Hou, B., Liu, Y., Ling, N., Liu, L., & Ren, Y. (2021). A fast lightweight 3D separable convolutional neural network with multi-input multi-output for moving object detection. IEEE Access, 9, 148433-148448.
Jocher, G., Chaurasia, A., Stoken, A., Borovec, J., Kwon, Y., Michael, K., . . . & Jain, M. (2022). ultralytics/yolov5: v7. 0-yolov5 sota realtime instance segmentation. Zenodo.
Lifesaver, O. (2023, 6). Collisions & Casualties by Year. Retrieved from Operation Lifesaver: oli.org/track-statistics/collisions-casualties-year
Lim, L. A., & Keles, H. Y. (2020). Learning multi-scale features for foreground segmentation. Pattern Analysis and Applications, 23, 1369-1380.
Lin, C., Yan, B., & Tan, W. (2018). Foreground detection in surveillance video with fully convolutional semantic network. 2018 25th IEEE International Conference on Image Processing (ICIP) (pp. 4118-4122). IEEE.
Ogden, B. D., & Cooper, C. (2019). Highway-rail crossing handbook. United States. Federal Highway Administration.
Radford, A., Kim, J. W., Hallacy, C., Ramesh, A., Goh, G., Agarwal, S., . . . & Sutskever, I. (2021 July). Learning transferable visual models from natural language supervision. In International conference on machine learning (pp. 8748-8763). PMLR.
Rahmon, G., Bunyak, F., Seetharaman, G., & Palaniappan, K. (2021). Motion U-Net: multi-cue encoder-decoder network for motion segmentation. 2020 25th International Conference on Pattern Recognition (ICPR) (pp. 8125-8132). IEEE.
Sikora, P., Malina, L., Kiac, M., Martinasek, Z., Riha, K., Prinosil, J., . . . . Srivastava, G. (2020). Artificial intelligence-based surveillance system for railway crossing traffic. IEEE Sensors Journal, 21, 15515-15526.
St-Charles, P.-L., Bilodeau, G.-A., & Bergevin, R. (2014). SuBSENSE: A universal change detection method with local adaptive sensitivity. IEEE Transactions on Image Processing, 24, 359--373.
Ultralytics. (2023). YOLO by Ultralytics, Retrieved from github.com/ultralytics/ultralytics.
Valipour, S., Siam, M., Jagersand, M., & Ray, N. (2017 March). Recurrent fully convolutional networks for video segmentation. In 2017 IEEE Winter Conference on Applications of Computer Vision (WACV) (pp. 29-36). IEEE.
Varadarajan, S., Miller, P., & Zhou, H. (2015). Region-based mixture of gaussians modelling for foreground detection in dynamic scenes. Pattern Recognition, 48 (11), 3488-3503.
Vijayan, M., Raguraman, P., & Mohan, R. (2021). A fully residual convolutional neural network for background subtraction. Pattern Recognition Letters, 146, 63-69.
Wang, Y., & Yu, P. (2021). A fast intrusion detection method for high-speed railway clearance based on low-cost embedded GPUs. Sensors, 21, 7279.
Wang, Y., Jodoin, P. M., Porikli, F., Konrad, J., Benezeth, Y., & Ishwar, P. (2014). CDnet 2014: An expanded change detection benchmark dataset. In Proceedings of the IEEE conference on computer vision and pattern recognition workshops (pp. 387-394).
Wojke, N., Bewley, A., & Paulus, D. (2017 September). Simple online and realtime tracking with a deep association metric. In 2017 IEEE international conference on image processing (ICIP) (pp. 3645-3649). IEEE.
Xu, C., Liu, H., Li, T., Zhang, Y., Li, T., & Li, G. (2022). Cascaded Feature-Mask Fusion for Foreground Segmentation. IEEE Open Journal of Intelligent Transportation Systems, 3, 340-350.
Yang, L., Li, J., Luo, Y., Zhao, Y., Cheng, H., & Li, J. (2017). Deep background modeling using fully convolutional network. IEEE Transactions on Intelligent Transportation Systems, 19, 254-262.
Zaman, A., Ren, B., & Liu, X. (2019). Artificial intelligence-aided automated detection of railroad trespassing. Transportation research record, 2673 (7), 25-37.
Zhang, Z., Zaman, A., Xu, J., & Liu, X. (2022). Artificial intelligence-aided railroad trespassing detection and data analytics: Methodology and a case study. Accident Analysis & Prevention, 168, 106594.

Various modifications and variations of the described methods, compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A portable railroad grade crossing monitoring system comprising:
at least one input head configured to both identify and discern foreground objects within at least one visual scene;
at least three processors configured to act independently from one another comprising;
a first processor configured to process foreground detection;
a second processor configured to process object classification;
a third processor configured to process motion tracking; and
wherein each processor is assigned to a separate central processing unit core;
the at least one input head further configured to compare at least one current frame and at least one static background and further configured to isolate at least one dynamic object or at least one static object in a foreground of the at least one visual scene to detect at least one moving object against at least one background image.

2. The portable railroad grade crossing monitoring system of claim 1, wherein the at least one background image changes over time.

3. The portable railroad grade crossing monitoring system of claim 1, wherein the input head is supported by multiple algorithms.

4. The portable railroad grade crossing monitoring system of claim 3, wherein the multiple algorithms are configured to analyze at least one temporal and at least one spatial variation between consecutive video frames to dynamically differentiate between foreground elements and background scenery.

5. The portable railroad grade crossing monitoring system of claim 3, wherein the monitoring system employs at least one data association technique algorithm and at least one motion prediction algorithm to track a trajectory of at least one detected object across successive video frames.

6. The portable railroad grade crossing monitoring system of claim 1, wherein the monitoring system employs Zero-shot learning to recognize and classify at least one image from at least one category to which the monitoring system was never exposed during training of the monitoring system.

7. The portable railroad grade crossing monitoring system of claim 1, wherein the monitoring system employs an anchor-free methodology instead of an anchor-based methodology.

8. The portable railroad grade crossing monitoring system of claim 1, wherein the monitoring system maintains consistent object identities across multiple frames in dynamic environments.

9. The portable railroad grade crossing monitoring system of claim 1, wherein the multiple processors transfer information to one another via at least one queue.

10. The portable railroad grade crossing monitoring system of claim 1, wherein the monitoring system detects and segments at least one foreground object from a background and classifies the at least one foreground object into at least one category and tracks movement of the at least one foreground object across multiple frames.

11. A method for monitoring a railroad grade crossing comprising:
positioning at least one device comprising at least one input head at a railroad grade crossing;
configuring the at least one input head to harmonize weight between at least one video frame input and at least one background image input;
wherein the at least one input head transforms both the at least one video frame input and at least one background image input into at least one first feature map and at least one second feature map wherein the at least one first feature map and the at least one second feature map are identical in size; and
configuring the at least one device to comprise at least three processors to act independently from one another including;
a first processor configured to process foreground detection;
a second processor configured to process object classification;
a third processor configured to process motion tracking; and
wherein each processor is assigned to a separate central processing unit core;

12. The method of monitoring a railroad grade crossing of claim 11, including configuring the at least one input head to comprise at least a first branch and a second branch with the first branch and the second branch are further configured to have at least one single convolutional layer.

13. The method of monitoring a railroad grade crossing of claim 12, including configuring the first branch to process the at least one video frame input and the second branch to process the at least one background image input.

14. The method of monitoring a railroad grade crossing of claim 11, including configuring the at least one first feature map and the at least one second feature map to be concatenated to form at least one combined channel feature map.

15. The method of monitoring a railroad grade crossing of claim 14, including configuring the at least one combined channel feature map to undergo a final convolutional transformation to compress the at least one combined channel feature map into a compressed output.

16. The method of monitoring a railroad grade crossing of claim 15, further comprising configuring the compressed output as compatible with a backbone of a YOLOv8 architecture.

17. The method of monitoring a railroad grade crossing of claim 11, including configuring the input head to perform foreground detection.

18. The method of monitoring a railroad grade crossing of claim 11, including configuring the input head classify foreground objects in a context-aware manner.

19. The method of monitoring a railroad grade crossing of claim 11, including configuring the device to maintain consistent object identities across frames in at least one dynamic environment.

20. The method of monitoring a railroad grade crossing of claim 11, including configuring the device to detect and segment at least one foreground object from a background and classify the at least one foreground object into at least one category and track movement of the at least one foreground object across multiple frames.
